(19) United States
(12) Patent Application Publication
(10) Pub. No.: US 2021/0306475 A1
(43) Pub. Date: Sep. 30, 2021

(54) NON-VOLATILE STORAGE MEDIUM, DATA TRANSMISSION/RECEPTION METHOD, AND IMAGE PROCESSING SYSTEM

(71) Applicant: TOSHIBA TEC KABUSHIKI KAISHA, Tokyo (JP)

(72) Inventor: Tetsuya ISHIDA, Sunto Shizuoka (JP)

(21) Appl. No.: 16/828,171

(22) Filed: Mar. 24, 2020

(51) Int. Cl. H04N 1/00; H04L 12/26

(52) U.S. Cl. CPC H04N 1/00214; H04N 1/00307; H04L 43/0817; H04L 43/0811

(57) ABSTRACT

In a multifunctional peripheral system an image processing apparatus includes a first communication interface and a wireless terminal includes a processor and a second communication interface. The wireless terminal is configured to communicate with the image processing apparatus via the first communication interface and stores a program that when executed by the processor permits the wireless terminal to request that the image processing apparatus perform a function (such as, for example, printing or document scanning) and transmit or receive data related to the function to and from the wireless terminal. The program further causes the wireless terminal to monitor the quality of the communication between the wireless terminal and the image processing apparatus and control the communication according to the monitored quality of the communication.

### FIELD

The present disclosure relates to systems, methods, and apparatuses for transmitting data to, and receiving data from, an image processing apparatus.

### BACKGROUND

In recent years, technologies for making functions of various peripheral devices, such as an MFP (Multi-Function peripheral) apparatus, available from wireless terminals, such as a smartphone or a tablet, have been developed. For example, a wireless terminal requests, by wireless communication, a reading of a document placed on an MFP. The wireless terminal may then receive image data corresponding to the document that has been read (hereinafter referred to as “scan data”) in return from the MFP through wireless communication. In other examples, when the wireless terminal instructs the MFP to perform printing, the wireless terminal transmits the data to be printed (hereinafter, referred to as “print data”) to the MFP. However, when transmission and reception of various data is performed by wireless communication between the wireless terminal and the MFP, the wireless communication quality may deteriorate, and the communication speed may decrease. If the wireless communication quality deteriorates, retransmission of packets may be frequently required due to the occurrence of a communication error, and there may be a case in which a long time will be required to complete the transmission and reception of data. Therefore, deterioration in the wireless communication quality may delay the completion of data transmission and reception, and may also unnecessarily consume a battery of the wireless terminal.

When a communication error occurs frequently, the communication between the MFP and the wireless terminal may be interrupted. In such a case, the data being transmitted and received will be discarded. Therefore, when the transmission/reception is re-executed after the communication is restored, the transmission/reception of the data must be restarted from the beginning. Furthermore, if communication is disconnected during transmission and reception of scan data, there may be a case in which the document must be read/scanned again. In this way, in the past, when various data are wirelessly transmitted and received between a peripheral device, such as an MFP, and a wireless communication terminal, wasteful power consumption may occur when the wireless communication quality is poor or becomes poor.

### BRIEF DESCRIPTION OF THE DRAWINGS

FIG. 1 is a schematic diagram of an MFP system according to a first embodiment.

FIG. 2 depicts a configuration of an MFP according to a first embodiment.

FIG. 3 depicts a configuration of a wireless terminal according to a first embodiment.

FIG. 4 is a sequence diagram of a processing flow related to use of a scanner function in an MFP system according to a first embodiment.

FIG. 5 is a flowchart of a communication monitoring process performed by a wireless terminal according to a first embodiment.

FIG. 6 is another sequence diagram of a processing flow related to use of a scanner function in an MFP system according to a first embodiment.

FIG. 7 is another sequence diagram of a processing flow related to use of a scanner function in an MFP system according to a first embodiment.

FIG. 8 is a flowchart of a communication monitoring process performed by a wireless terminal according to a second embodiment.

### DETAILED DESCRIPTION

According to one embodiment, a peripheral system includes an image processing apparatus including a first communication interface and a wireless terminal including a processor and a second communication interface. The wireless terminal is configured to communicate with the image processing apparatus via the first communication interface and stores a program that when executed by the processor permits the wireless terminal to request that the image processing apparatus perform a function and transmit or receive data related to the function to or from the wireless terminal. The program further causes the wireless terminal to monitor the quality of the communication between the wireless terminal and the image processing apparatus, and then control the communication between the wireless terminal and the image processing apparatus according to the monitored quality of the communication.

Hereinafter, certain examples of a peripheral system, a data transmission/reception method, and wireless terminal device storing a program according the present disclosure will be described with reference to the drawings.

### First Embodiment

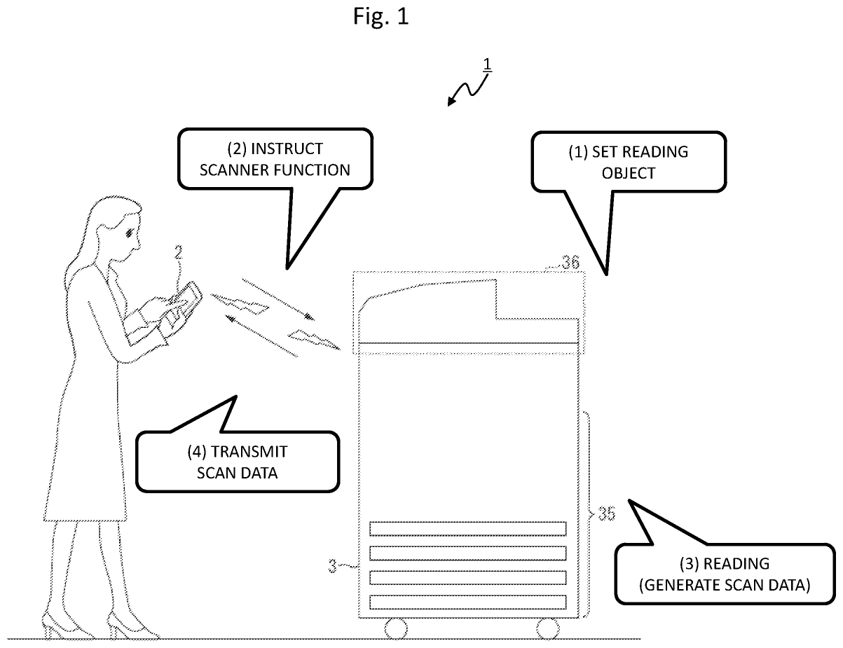

FIG. 1 is a schematic diagram showing a specific example of a MFP system according to the first embodiment. The MFP system 1 is a system that enables various functions of the MFP 3 to be available from the wireless terminal 2. For example, the wireless terminal 2 is an information communication terminal having a wireless communication function such as a smartphone or a tablet. The wireless terminal 2 and the MFP 3 are configured to be able to communicate with each other. For example, the wireless terminal 2 is installed with an application (hereinafter, referred to as “MFP application”) that makes the function(s) of the MFP 3 available via wireless communication. The user can remotely use various functions (hereinafter referred to as “MFP functions”) provided by the MFP 3 by operating the MFP application. For example, the MFP functions include a printer function, a scanner function, a copy function, a fax function, and the like.

For example, FIG. 1 shows a specific example of the MFP system 1 in which the scanner function of the MFP 3 is being made available to the wireless terminal 2. In this case, (1) the user first places the reading object in or on the scanner 36 of the MFP 3. After the user places the object (e.g., a document) to be read/scanned, (2) the user instructs the MFP 3 to execute the scanner function by operating the MFP application of the wireless terminal 2. In response to the execution instruction, (3) MFP 3 generates scan data by reading the object which was placed in/on the MFP 3. When the scan data has been generated, (4) the MFP 3 then transmits the generated scan data to the wireless terminal 2.

FIG. 1 depicts a case in which the wireless terminal 2 communicates directly with the MFP 3 without passing through an access point or the like. One such direct wireless communication method includes, for example, Wi-Fi Direct®, AD hoc mode in wireless LAN (Local Area Network), and the like. In general, the wireless standard utilized is not limited to any specific one or type. For example, the wireless standard may conform to the IEEE (Institute of Electrical and Electronics Engineers) 802.11 series. In other examples, the wireless standard may be based on a short-distance wireless standard such as Bluetooth® or ZigBee®.

In still other examples, the wireless terminal 2 may communicate with the MFP 3 via a predetermined access point (network router or the like) instead of directly performing wireless communication with the MFP 3. In such a case, the MFP 3 and the access point may be connected by radio links (a wireless network), or may be connected by wire. That is, the wireless terminal 2 is capable of communicating with the MFP 3, but in some examples a wired path (linkage) may be included in a part of the communication path between the wireless terminal 2 and the MFP 3. Furthermore, the MFP 3 is not limited to any one particular communication path or method and may be configured to communicate with the wireless terminal 2 through a plurality of communication paths using a variety of protocols/methods.

The MFP system 1 enables various MFP functions of the MFP 3 (including the scanner function) to be used via wireless communication. Furthermore, the MFP system 1 in the first embodiment can temporarily stop and then resume the transmission and reception of data related to use of a MFP function during the execution of a MFP function. As a result, the MFP system 1 of the first embodiment can suppress wasteful power consumption that might otherwise be due to continuous attempts at wireless communication. The MFP system 1 according to the first embodiment will now be described using the scanner function as an example of a MFP function. Other MFP functions besides the scanner function are similarly implemented in the MFP system 1.

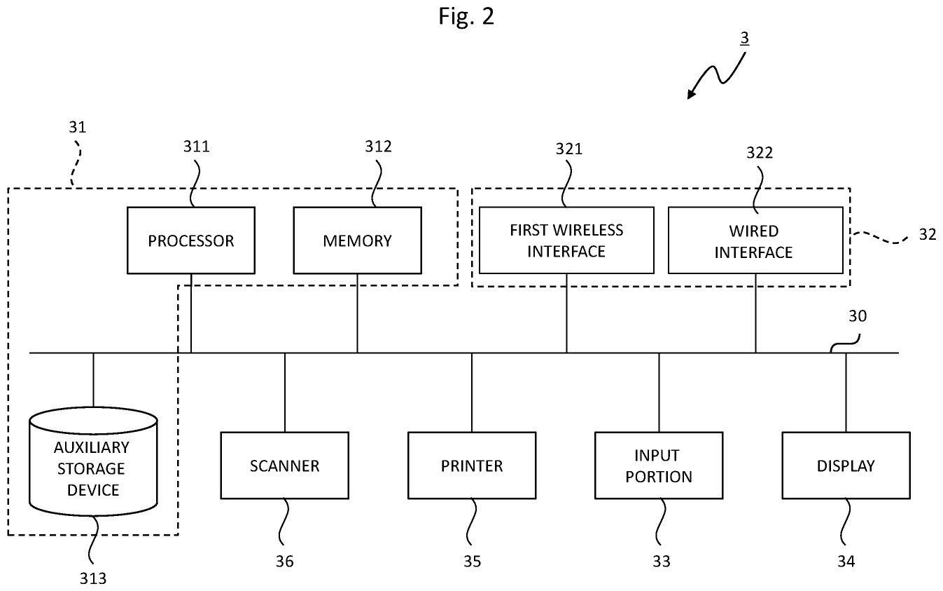

FIG. 2 is a diagram illustrating an example of the configuration of the MFP 3 according to the first embodiment. For example, the MFP 3 includes a processor 311, a memory 312, an auxiliary storage device 313, a communication unit 32, an input portion 33, a display 34, a printer 35, a scanner 36, and a bus 30 for connecting these various components. The MFP 3 functions as an information processing apparatus that provides an MFP function by reading and executing a program that is stored in the auxiliary storage device 313. The stored program can be loaded to the memory 312 and executed by the processor 311. For example, the program described herein can be a program such as BIOS (Basic Input Output System), OS (Operating system), or various firmware, or may be implemented in conjunction with such programs.

The processor 311, the memory 312, and the auxiliary storage device 313 are not limited to any specific types as long as the MFP 3 can function as an information processing apparatus that provides an MFP function. For example, the processor 311 can be a CPU (Central Processing Unit). The processor 311 may include or be a Graphics Processing Unit (GPU). The memory 312 can be a random access memory (RAM). In some examples, the memory 312 may be a read only memory (ROM). The auxiliary storage device 313 can be a storage device such as a magnetic hard disk device or a semiconductor storage device (also referred to as a solid-state drive (SSD)).

All or a part of the functions of the MFP 3 may be realized by using hardware such as an ASIC (Application Specific Integrated Circuit), a PLD (Programmable Logic Device), or an FPGA (Field Programmable Gate Array). In some examples, the relevant program may be recorded on a non-transitory computer-readable recording medium. A computer-readable recording medium is, for example, a flexible disk, a magneto-optical disk, a portable storage medium such as a ROM, a CD-ROM, or the like, a storage device such as a hard disk incorporated in a computer system, or the like. In some examples, the program may be transmitted over a telecommunications line or the like.

The processor 311, the memory 312, and the auxiliary storage device 313 serve as a controller that causes the MFP 3 to function as an information processing apparatus that provides an MFP function. Therefore, in the following description, the processor 311, the memory 312, and the auxiliary storage device 313 are sometimes collectively referred to as a control unit 31. The control unit 31 has a function of generating scan data by executing the scanner function and also temporarily stopping and then resuming transmission of the generated scan data.

Specifically, in this first embodiment, the control unit 31 temporarily stops (suspends) transmission of scan data in response to a request from the wireless terminal 2. At this time, the control unit 31 does not delete the generated scan data to be transmitted from the auxiliary storage device 313, but rather retains at least the un-transmitted portion the generated scan data in the auxiliary storage device 313 for later resumption of transmission. Thus, the MFP 3 can restart the transmission of the un-transmitted scan data. In this example, when the transmission of the scan data is temporarily stopped, the control unit 31 records only the untransmitted portion of the scan data in the auxiliary storage device 313. In other examples, the control unit 31 may record the whole of the generated scanned data in the auxiliary storage device 313 after recording or noting the already transmitted data amount. In general, the control unit 31 deletes the generated scan data from the auxiliary storage device 313 once the transmission of the entire scan data has been successfully completed.

The configuration of the control unit 31 is not limited to any specific arrangement as long as it can cause the MFP 3 to function as an information processing apparatus that provides the MFP function by executing a program.

The communication unit 32 is a communication interface. The communication unit 32 connects the MFP 3 and the wireless terminal 2 to each other so as to enable each to communicate with the other. Here, it is assumed that the communication unit 32 includes a wireless interface 321 and a wired interface 322. Thus, the MFP 3 can directly or indirectly communicate with the wireless terminal 2 in various examples.

The input portion 33 comprises user input devices such as an operating panel, a touch panel, a mouse, and a keyboard. The input portion 33 accepts input of various operations to the MFP 3, and outputs the input information to the processor 311. The processor 311 executes processing according to the input information, whereby various MFP functions are executed in the MFP 3 according to a user's instructions or the like.

The display 34 comprises a display device such as a CRT (Cathode Ray Tube) display, a liquid crystal display, an organic EL (Electro-Luminescence) display, or the like. The display 34 can be used to display various kinds of information related to the operation of the MFP 3. For example, information to be displayed by the display 34 is output from the processor 311 for display.

The printer 35 forms an image on a sheet based on, for example, scan data generated by the scanner 36 or scan data (or other data) received via a communication path. For example, the printer 35 includes an image forming unit for forming a desired image on a sheet, a sheet accommodating unit for accommodating a sheet, and the like. In this example, the image forming unit forms an electrostatic latent image on a photosensitive drum based on the scan data, and the transfers an image corresponding to the electrostatic latent image to the sheet by using a developer. The developer is, for example, a toner. In some examples, the toner may be a decolorable toner, which is a specialized toner which decolorizes at or above a predetermined temperature. The image forming unit fixes the toner image on the sheet by heating and pressing the sheet in a fixing unit. The sheet on which the image is formed may be a sheet from a sheet storage portion of the MFP 3 or a sheet that has been manually inserted/fed to the MFP 3.

The scanner 36 reads the appearance of the object to be read as the regions of light and dark based on reflected light in accordance with the instruction of the control unit 31. For example, the scanner 36 captures an image of an object to be read by using an image sensor such as a CCD (Charge coupled device) or a CIS (contact image sensor). The scanner 36 outputs generated scan data to the control unit 31.

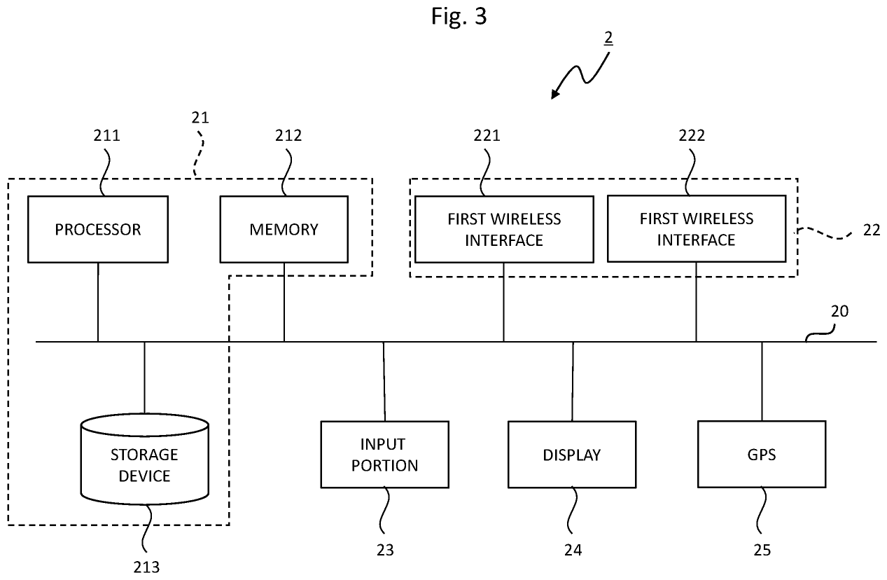

FIG. 3 is a diagram illustrating an example of a configuration of the wireless terminal 2 according to the first embodiment. For example, the wireless terminal 2 includes a processor 211, a memory 212, a storage device 213, a wireless communication unit 22, an input portion 23, a display 24, a global positioning system (GPS) 25, and a bus 20. The wireless terminal 2 functions as an information processing apparatus having a wireless communication function by reading and executing a program stored in the storage device 213 by the processor 211. For example, the program described in this context is a program such as BIOS (Basic Input Output System), OS (Operating system), or various firmware, or may be implemented in conjunction with such programs.

The processor 211, the memory 212, and the storage device 213 are not limited to any specific types as long as they can cause the wireless terminal 2 to function as an information processing apparatus having a wireless communication function. For example, the processor 211 may be a CPU. The processor 211 may include or be a GPU. The memory 212 can be RAM or ROM, or a combination of RAM and ROM. The storage device 213 comprises a storage device such as a magnetic hard disk device or a semiconductor storage device.

All or part of the functions of the wireless terminal 2 may be realized by using hardware such as an ASIC, a PLD, an FPGA, or the like. The program may be recorded on a non-transitory computer-readable recording medium. The computer-readable recording medium can be, for example, a flexible disk, a magneto-optical disk, a portable medium such as a ROM, a CD-ROM, or the like, a storage device such as a hard disk incorporated in a computer system, or the like. The program may be transmitted over a telecommunications line or the like.

The processor 211, the memory 212, and the storage device 213 collectively serve as a controller that causes the wireless terminal 2 to function as an information processing apparatus having wireless communication functions. Therefore, in the following description, the processor 211, the memory 212, and the storage device 213 are sometimes collectively referred to as a control unit 21. In the present example, the control unit 21 provides a user interface that makes it possible for a user to use the scanner function of the MFP 3, for example, by executing a MFP application.

Specifically, in this example, the control unit 21 instructs the MFP 3 to execute the scan function according to an input operation of the user. The control unit 21 receives the scan data as generated by the execution of the scan function from the MFP 3. During the receiving of the scan data from the MFP 3, the control unit 21 monitors the quality of wireless communication. The control unit 21 monitors and controls wireless communication between the wireless terminal 2 and the MFP 3 according to the monitored quality of the wireless communication.

Specifically, when wireless communication is being received from the MFP 3, the control unit 21 will temporarily suspend the reception of the scan data when the quality of wireless communication becomes less than some predetermined threshold value. When the reception of the scan data is temporarily suspended, the control unit 21 will restart the reception of the scan data when the quality of wireless communication improves to be above (better than) some threshold value.

The wireless communication unit 22 is a communication interface. The wireless communication unit 22 connects the wireless terminal 2 and the MFP 3 to each other. In this first embodiment, the wireless communication unit 22 includes a first wireless interface 221 and a second wireless interface 222. Thus, the wireless terminal 2 can communicate with the MFP 3 through different wireless communication paths. For example, the first wireless interface 221 is a communication interface that connects to a mobile phone network such as 3G (third generation) or 4G (fourth generation). The second wireless interface 222 is, for example, a wireless LAN communication interface such as Wi-Fi®.

The input portion 23 comprises input devices such as a touch panel, a mouse, a keyboard, or the like. The input portion 23 receives user inputs of various operations, and outputs the input information to the processor 211. The processor 211 instructs the MFP application to execute processing corresponding to the input information, thereby instructing the MFP 3 to execute various MFP functions.

The display 24 is a display device such as a CRT display, a liquid crystal display, or an organic EL display. The display 24 displays various pieces of information related to the operations of the wireless terminal 2. For example, an operation screen of the MFP application is displayed on the display 24. In general, the information to be displayed on the display 24 is output by the processor 211.

A GPS 25 has a function of communicating with a GPS satellite and acquiring positional information from the GPS satellite. The GPS 25 outputs the acquired position information to the control unit 21.

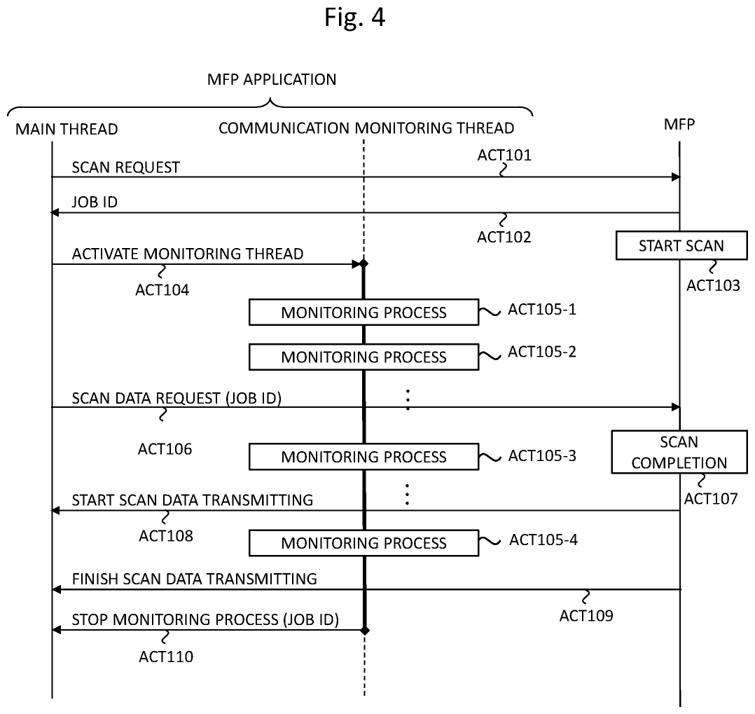

FIG. 4 is a first sequence diagram showing the flow of the processing related to the use of the scanner function in the MFP system 1 according to the first embodiment. Here, a case will be described in which the wireless terminal 2 is already activated and an operation for instructing the MFP application to execute the scanner function has been input to the wireless terminal 2 by a user. First, the wireless terminal 2 requests the MFP 3 to execute the scanner function in response to the user input instructing the execution of the scanner function (ACT 101, scan request).

The MFP 3 allocates management information (e.g., a job ID) to the request, and notifies the MFP application of the allocated job ID (ACT 102). By the notification of the job ID, the wireless terminal 2 is notified that the MFP 3 has received the execution request of the scanner function (that is, the scan request). After receiving scan request, the MFP 3 starts reading the sheet that is on the document table (scanner bed) of the MFP 3 (ACT 103, start scan).

In response to the notification of the job ID, the wireless terminal 2 activates a communication monitoring thread in the MFP application (ACT 104). The communication monitoring thread is a thread that repeatedly executes a communication monitoring process (ACT 105-1 to 105-4) until the transmission of the scan data of the corresponding job ID has been completed. The communication monitoring process monitors the quality of wireless communication happening between the wireless terminal 2 and the MFP 3. The communication monitoring thread is realized by execution of a communication monitoring program or sub-routine. The communication monitoring program may be a part of the MFP application itself or may be another application called upon by the MFP application.

After the starting of the monitoring process, the MFP application requests transmission of the scan data corresponding to the job ID as generated by the scanner function of the MFP 3 (ACT 106, scan data request). Upon receiving the scan data request, the MFP 3 starts transmission of the generated scan data (ACT 108) after completion of the execution of the read/scanning process corresponding to the job ID (ACT 107). For example, the MFP 3 divides the scan data into a plurality of data packets and begins to transmits the individual data packets. Upon completion of the transmission of all the data packets, the MFP 3 completes the transmission of the scan data (ACT 109). During the processes, the communication monitoring thread repeatedly monitors the wireless communication quality of the wireless terminal 2 until the transmission of the scan data is finally completed. FIG. 4 shows the flow of processing when the transmission of scan data is completed without any deterioration in the wireless communication quality during the processing.

Once wireless terminal 2 receives an indication of the completion of the scan data reception processing for a job ID, the wireless terminal 2 terminates the communication monitoring thread for the corresponding job ID (ACT 110).

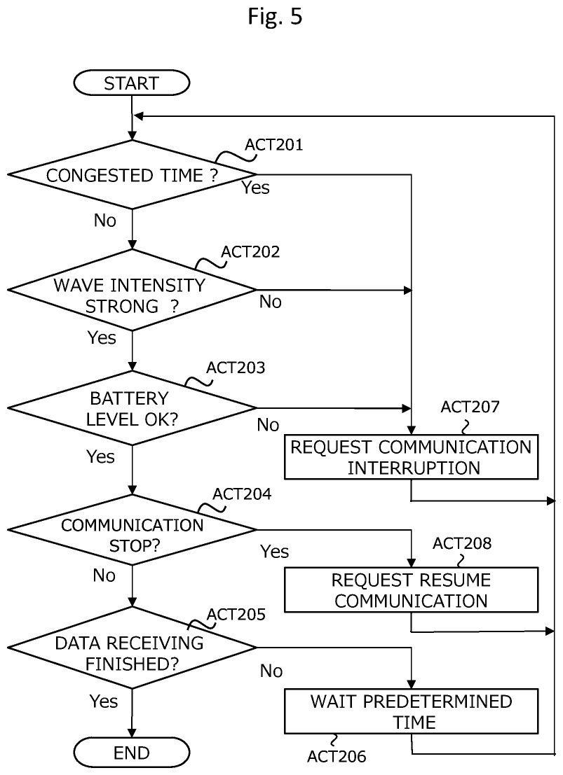

FIG. 5 is a flowchart showing a flow of the communication monitoring process executed by the wireless terminal 2 according to the first embodiment. First, in the wireless terminal 2, the control unit 21 judges whether or not the current time is within a congested time zone (ACT 201). A congested time zone is a predetermined time period during which it is expected that the communication path to the MFP 3 is highly likely to be engaged or heavily utilized. When the current time is not included in the congested time zone (ACT 201, NO), the control unit 21 determines whether or not the received radio wave intensity is equal to or greater than a predetermined threshold (ACT 202). For example, the received radio wave intensity is an RSSI (Received Signal Strength Indicator). Here, it is assumed that the wireless communication unit 22 itself provides a function of measuring the received radio wave intensity, and the control unit 21 can acquire a measured value for the received radio wave intensity from the wireless communication unit 22. In this example, the control unit 21 determines whether or not the received radio wave intensity is equal to or greater than a threshold value for the communication interface to be used to receive the scan data. The threshold value may be set to any value depending on the wireless communication quality considered necessary or otherwise desirable in the relevant communication context or environment.

When the received radio wave intensity is equal to or greater than the threshold value (ACT 202, YES), the control unit 21 then determines whether or not the remaining battery level of the wireless terminal 2 is equal to or greater than some predetermined threshold (ACT 203). Here, it is assumed that the control unit 21 measures the present output voltage of a battery device of the wireless terminal 2 to thereby measure the remaining battery power. The threshold value may be set to any arbitrary value in accordance with the remaining battery amount expected to be required to receive the scan data from MFP 3. When the battery level is greater than or equal the threshold value (“Battery level is OK”) (ACT 203, YES), the control unit 21 then determines whether or not reception of the scan data should be temporarily stopped (ACT 204). The communication/reception of the scan data is controlled based on the wireless communication quality of the wireless terminal 2.

When the reception of the scan data has not been temporarily stopped (i.e., the reception state is ready), the control unit 21 next determines whether the reception of the scan data has already been completed (ACT 205). When the reception of the scan data has been completed (ACT 205—YES), the control unit 21 terminates the communication monitoring process (i.e., ends the communication monitoring thread). On the other hand, when the reception of the scan data is not yet completed (ACT 205, NO), the control unit 21 returns the process to ACT 201 after a waiting of a predetermined time period (ACT 206). When the current time is included in the congested time zone in ACT 201 (ACT 201, YES), the control unit 21 requests the MFP 3 to pause the transmission of scan data (ACT 207). After the control unit 21 requests the MFP 3 to pause the transmission of the scan data, the control unit 11 returns the process to ACT 201.

In ACT 204, when the reception of the scan data has been temporarily stopped (ACT 204, YES), the control unit 21 requests the MFP 3 to resume transmission of scan data (ACT 208). After requesting the MFP 3 to resume the transmission of the scan data, the control unit 21 returns the process to the ACT 201.

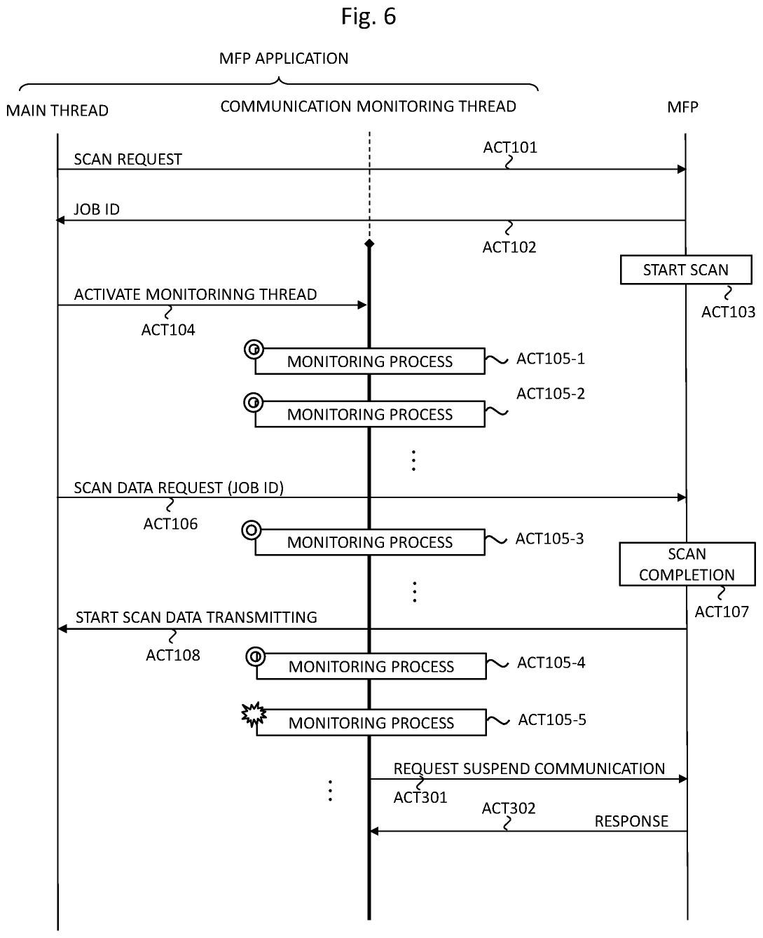

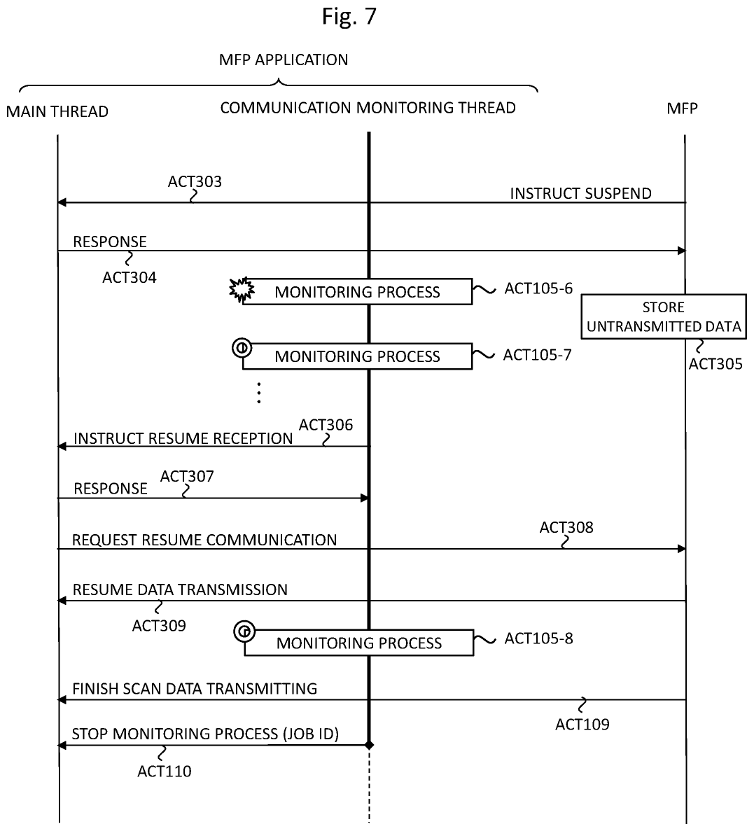

FIGS. 6 and 7 are second sequence diagrams showing the flow of processing related to the use of the scanner function in the MFP system 1 according to the first embodiment. In FIGS. 6 and 7, the processing up until the MFP 3 starts transmission of scan data is the same as that in FIG. 4. Therefore, in FIGS. 6 and 7, the same reference numerals as those used in FIG. 4 denote substantially the same processing, and description thereof will not be repeated.

In FIG. 6, the control unit 21 detects degradation in the wireless communication quality during the reception of the scan data in the communication quality monitoring process of the ACT 105-5. Accordingly, the control unit 21 request temporary suspension of communication (transmission of the scan data for the present job ID) (ACT 105-5). More specifically, the control unit 21 requests the MFP 3 to suspend the transmission of scan data (ACT 301). At this time, the control unit 21 notifies the MFP 3 of the job ID corresponding to the scan data presently being received and the reason for temporarily stopping the reception of the scan data. The MFP 3 sends a response notifying a receipt of the request to the control unit 21 (communication monitoring thread) (ACT 302).

As depicted in FIG. 7, the MFP 3 instructs the control unit 21 (main thread) to temporarily stop the reception of scan data (ACT 303). In correspondence with this, the control unit 21 temporarily stops the reception of the scan data, and in response notifies the MFP 3 of the suspension (ACT 304). In response to this notification, the MFP 3 records and stores the data of at least the untransmitted portion of the scanned data that has been temporarily stopped during transmission in the auxiliary storage device 313 (ACT 305).

Even while the transmission/reception of the scan data is temporarily stopped, the wireless terminal 2 continues to execute the communication monitoring process of the control unit 21 (communication monitoring thread). FIGS. 6 and 7 together show a case where a deterioration in the wireless communication quality is detected in ACT 105-5 (FIG. 6), the wireless communication quality is again detected as below threshold quality in ACT 105-6 (FIG. 7) and then the wireless communication quality is detected as recovered in ACT 105-7 (FIG. 7). In response to the recovery in the wireless communication quality detected in ACT 105-7, the control unit 21 (communication monitoring thread) resumes the reception of the scan data that was temporarily stopped. Specifically, the communication monitoring thread detects the recovery of the communication state, and instructs the main thread to resume the reception of the scan data that was temporarily stopped (ACT 306). At this time, the communication monitoring thread notifies the main thread of the job ID associated with the communication status monitoring thread. Note, that the communication monitoring thread continues monitoring communication quality even after the resumption of the scan data transmission (monitoring process, ACT 105-8).

In response to this notification, the main thread acknowledges that the communication status monitoring thread has been accepted (ACT 307). After this acknowledging response is sent, the main thread next requests the MFP 3 to resume the transmission of the designated scan data (ACT 308). At this time, the main thread notifies the MFP 3 of the job ID notified from the communication monitoring thread as the identification information of the scan data for which the transmission should be resumed. In response to this request, the MFP 3 resumes the transmission of the scan data identified by the notified job ID (ACT 309). Then, the MFP 3 ultimately completes the transmission of the scan data in ACT 109. In response to completion of the communication of the scan data, the wireless terminal 2 finally stops the communication monitoring thread that the control unit 21 (main thread) started with respect to the scan data (ACT 110).

In the MFP system 1 of the first embodiment, the wireless terminal 2 provides the monitoring function for the wireless communication state while the scan data is being received. Furthermore, the wireless terminal 2 itself has the function of temporarily stopping communication of scan data when a deterioration in the wireless communication quality is detected. The MFP 3 has the function of storing the scan data when the transmission of scan data is temporarily stopped, and restarting transmission of the scan data when the wireless terminal 2 provides notification of a recovery in communication quality. The wireless terminal 2 has the function causing there-starting of communication of the scan data when the recovery of the wireless communication quality occurs. With such a configuration, the MFP system 1 of the first embodiment can reduce the consumption of the battery charge in the wireless terminal 2 that would otherwise be caused by the deterioration of the wireless communication quality.

The temporary stop and restart of data transmission and reception based on wireless communication quality may be performed for transmissions and receptions other than those related to scan data. For example, the transmission and reception of print data may be paused and restarted based on wireless communication quality.

### Second Embodiment

The MFP system 1 in a second embodiment includes a wireless terminal 2 and an MFP 3 similar to those in the first embodiment (see FIGS. 2 and 3). However, the wireless terminal 2 according to the second embodiment is different from the wireless terminal 2 according to the first embodiment in part of the processing that is performed in the communication quality monitoring process. The other configurations of the wireless terminal 2 and the MFP 3 according to the second embodiment are similar to those of the wireless terminal 2 and the MFP 3 according to the second embodiment of the present disclosure. Therefore, in the second embodiment, the configuration of the wireless terminal 2 and the MFP 3 can be considered to correspond to those already depicted in FIG. 2 and FIG. 3.

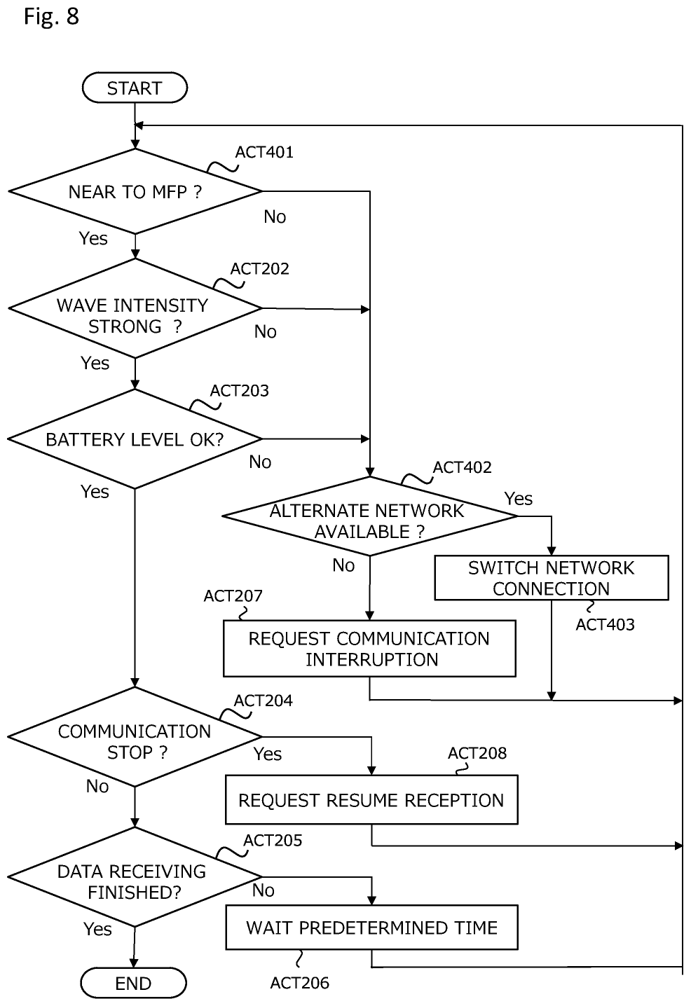

FIG. 8 is a flowchart of a communication monitoring process executed by a wireless terminal 2 according to the second embodiment. In FIG. 8, some of the processes are the same as those depicted in FIG. 5. Therefore, in FIG. 8, the same reference numerals are given to those processing aspects which are the same as those already explained in conjunction with FIG. 5, and a description of these aspects will be omitted. In general, the communication monitoring process in the second embodiment differs from the communication monitoring process in the first embodiment in that it is first determined whether or not the wireless terminal 2 and the MFP 3 are close to each other instead of making a determination as to whether or not the communication state is a congested time zone. Specifically, the control unit 21 determines whether or not the distance between the wireless terminal 2 and the MFP 3 is equal to or less than some predetermined threshold distance (ACT 401).

The communication monitoring process in the second embodiment further differs from the communication monitoring process in the first embodiment in that whether or not the communication of the scan data should be temporarily suspended is determined based on whether or not an alternate network is available (ACT 402). In this context, an alternative network is any other network that can be used for communication of the scan data. For example, when it is assumed that the first wireless interface 221 is an interface to be connected to a cellular telephone network and the second wireless interface 222 is an interface to be connected to Wi-Fi®, then the scan data might be received by Wi-Fi® communication if the cellular phone network not suitably available or vice versa. When an alternative network is available (ACT 402, YES), the control unit 21 switches the network connection currently in use to the alternate network without stopping the communication of the scan data (ACT 403). After switching to the alternative network, the control unit 21 returns the process to ACT 401.

On the other hand, when the substitute network is not available (ACT 402, NO), the control unit 21 temporarily stops communication of scan data similarly to the first embodiment (see ACT 207), and returns the process to ACT 401.

In the MFP system 1 of the second embodiment, the wireless terminal 2 further has a function of switching the network in use to an alternative network based on the distance between the wireless terminal 2 and the MFP 3. Moreover, the wireless terminal 2 has a function of switching a network in use to an alternative network when a deterioration in the wireless communication quality is detected on the presently in use network. With such a configuration, the MFP system 1 according to the second embodiment can reduce the consumption of the battery of the wireless terminal 2 that would otherwise occur due to the deterioration in the wireless communication quality.

According to at least one of the embodiments described above, the MFP application can suppress the consumption of the battery charge due to the deterioration in the wireless communication quality by causing the wireless terminal 2 initiate wireless communication from the MFP 3 (one example of an image processing apparatus), then monitoring the quality of wireless communication between the wireless terminal 2 (an example of a computer or the like) and the MFP 3, and controlling the wireless communication between the wireless terminal 2 and the MFP 3 in accordance with the quality of the wireless communication.

In the embodiments described above, transmission and reception of scan data were used an example of data transmission and reception between the wireless terminal 2 and the MFP 3. However, the transmission and reception of data between the wireless terminal 2 and the MFP 3 are not limited to the transmission and reception of scan data. For example, transmission and reception of data between the wireless terminal 2 and the MFP 3 may be transmission and reception of print data or the like. The transmission and reception of data between the wireless terminal 2 and the MFP 3 may be transmission and reception of data related to a facsimile function of the MFP 3. Thus, in each of the embodiments described above, the transmission and reception of any data type between the wireless terminal 2 and the MFP 3 can be temporarily stopped and restarted. Accordingly, it is possible to reduce the consumption of the battery of the wireless terminal 2 that might otherwise occur due to the deterioration of the wireless communication quality in the wireless terminal 2.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. Such embodiments and variations thereof are included within the scope and spirit of the present disclosure as well as the scope of the appended claims.

“Decolorization” in the present disclosure refers to an image initially formed in any color (including black or white) different from the color of the base paper or medium that is processed so as to become substantially invisible on the base paper or medium after the processing.

What is claimed:

1. A peripheral system, comprising:
an image processing apparatus including a first communication interface;
a wireless terminal including a processor and a second communication interface, the wireless terminal being configured to communicate with the image processing apparatus via the first communication interface and storing a program that when executed by the processor permits the wireless terminal to request that the image processing apparatus perform a function and transmit or receive data related to the function to or from the wireless terminal, the program further causing the wireless terminal to:
monitor the quality of the communication between the wireless terminal and the image processing apparatus, and
control the communication between the wireless terminal and the image processing apparatus according to the quality of the communication.

2. The peripheral system according to claim 1, wherein the program is stored in a non-volatile storage medium of the wireless terminal.

3. The peripheral system according to claim 1, wherein the control of the communication includes causing the image processing apparatus to suspend transmission of the data related to the function when the quality of the communication is monitored as less than a predetermined threshold.

4. The peripheral system according to claim 1, wherein the program further causes the wireless terminal to request suspension of the transmission of the data related to the function when the current time is within a predetermined time period corresponding to an expected congested communication period.

5. The peripheral system according to claim 1, wherein the program further causes the wireless terminal to evaluate a remaining battery amount and request a suspension of the transmission of the data related to the function when the remaining battery amount is less than predetermined value.

6. The peripheral system according to claim 1, wherein
the wireless terminal further includes a third wireless communication interface different from the second wireless communication interface, and
the program further causes the wireless terminal to switch from communicating with the image forming apparatus via the second wireless communication interface to communicating with the image forming apparatus via the third communication interface when the quality of the communication between the wireless terminal and the image processing apparatus via the second communication interface is less than a predetermined threshold.

7. The peripheral system according to claim 1, wherein
the control of the communication includes:
causing the image processing apparatus to suspend transmission of the data related to the function when the quality of the communication is monitored as less than a predetermined threshold; and
requesting the image processing apparatus to resume transmission of the data related to the function when the quality of the communication is monitored as above the predetermined threshold after being less than the predetermined threshold.

8. The peripheral system according to claim 1, wherein
the function is document scanning, and
the data related to the function is scanned image data.

9. The peripheral system according to claim 1, wherein
the function is image printing,
the data related to the function is image data to be printed by the image processing apparatus, and
the control of the communication includes causing the wireless terminal to suspend transmission of the image data when the quality of the communication is monitored as less than a predetermined threshold.

10. The peripheral system according to claim 9, wherein
the image processing apparatus includes a storage device, and
the image processing apparatus is configured to store whatever portion of the image data has been transmitted from the wireless terminal prior to the suspension of the transmission in the storage device.

11. The peripheral system according to claim 1, wherein
the image processing apparatus includes a storage device, and
the image processing apparatus is configured to store the data related to function.

12. The peripheral system according to claim 1, wherein the image processing apparatus is a multifunctional peripheral device.

13. A wireless terminal device, comprising:
a storage unit;
a processor configured to execute a program stored in the storage unit; and
a first communication interface configured to communicate with an image processing apparatus, wherein
the program when executed by the processor permits the wireless terminal device to request that the image processing apparatus perform a function and transmit or receive data related to the function to or from the wireless terminal device, the program further causing:
a quality of the communication between the first communication interface and the image processing apparatus to be monitored, and
the communication between the first communication interface and the image processing apparatus to be controlled according to the quality of the communication.

14. The wireless terminal device according to claim 13, wherein the control of the communication includes causing the image processing apparatus to suspend transmission of the data related to the function when the quality of the communication is monitored as less than a predetermined threshold.

15. The wireless terminal device according to claim 13, wherein the program further causes the processor to request suspension of the transmission of the data related to the function when the current time is within a predetermined time period corresponding to an expected congested communication period.

16. The wireless terminal device according to claim 13, wherein the program further causes the processor to evaluate a remaining battery amount and request a suspension of the transmission of the data related to the function when the remaining battery amount is less than predetermined value.

17. The wireless terminal device according to claim 13, further comprising:
a second wireless communication interface different from the first wireless communication interface, wherein
the program further causes the processor to switch from communicating with the image forming apparatus via the first wireless communication interface to communicating with the image forming apparatus via the second communication interface when the quality of the communication between the wireless terminal device and the image processing apparatus via the first communication interface is less than a predetermined threshold.

18. A method of controlling communication between a wireless terminal and an image forming apparatus, the method comprising:
with a communication from a wireless terminal, requesting an image processing apparatus to perform a function, the function including the transmission or reception of data to or from the wireless terminal;
monitoring the quality of the communication between the wireless terminal and the image processing apparatus during the transmission or reception of the data to or from the wireless terminal; and
controlling the communication between the wireless terminal and the image processing apparatus according to the quality of the communication.

19. The method according to claim 18, wherein the control of the communication includes causing the image processing apparatus to suspend transmission of data related to the function when the quality of the communication is monitored as less than a predetermined threshold.

20. The method according to claim 18, wherein the control of the communication includes:
causing the image processing apparatus to suspend transmission of the data related to the function when the quality of the communication is monitored as less than a predetermined threshold; and
requesting the image processing apparatus to resume transmission of the data related to the function when the quality of the communication is monitored as above the predetermined threshold after being less than the predetermined threshold.
